(19) United States
(12) Patent Application Publication
(10) Pub. No.: US 2012/0249010 A1
(43) Pub. Date: Oct. 4, 2012

(54) ELECTRODELESS PLASMA LAMP WITH VARIABLE VOLTAGE POWER SUPPLY

(75) Inventors: Gregg Hollingsworth, Tempe, AZ (US); David Wetle, Sunnyvale, CA (US); Sandeep Mudunuri, Sunnyvale, CA (US); Gary Adishian, Sonoma, CA (US)

(73) Assignee: Luxim Corporation, Sunnyvale, CA (US)

(21) Appl. No.: 13/368,990

(22) Filed: Feb. 8, 2012

Related U.S. Application Data
(60) Provisional application No. 61/440,614, filed on Feb. 8, 2011.

(51) Int. Cl. H05B 41/24

(52) U.S. Cl. 315/248

(57) ABSTRACT

The present disclosure relates to apparatuses and methods to control an electrodeless plasma light source. In various embodiments, an apparatus is provided that includes an electrodeless plasma lamp with a lamp driver circuit. The lamp driver circuit may include a voltage-controlled oscillator to provide radio frequency power to the electrodeless plasma lamp. A radio frequency power detector is coupled to an output of the voltage-controlled oscillator to detect a level of reflected power from the electrodeless plasma lamp. A microprocessor is configured to receive signals from the radio frequency power detector and control a frequency of the voltage-controlled oscillator to minimize the reflected power from the electrodeless plasma lamp.

### RELATED APPLICATION

This application claims priority benefit to U.S. Provisional Patent Application Ser. No. 61/440,614 entitled, “ELECTRODELESS PLASMA LAMP WITH VARIABLE VOLTAGE POWER SUPPLY,” filed Feb. 8, 2011, which is hereby incorporated by reference in its entirety.

### TECHNICAL FIELD

The disclosed subject matter relates to a plasma lamp for use in multiple applications including, but not limited to, general area lighting, projectors, and architectural and display in which lamps comprise at least one light source. The light source is formed by at least one electrodeless plasma source excited by electromagnetic radiation. The source of electromagnetic radiation could comprise a power amplifier using a transistor or transistors. In an example embodiment, the light source further comprises a power supply that is capable of varying the output voltage in accordance with the states of operation of the light source.

### BACKGROUND

Electrodeless plasma sources are known light sources and comprise a light bulb with a plasma material, where the plasma material emits light when it is excited by electromagnetic radiation, a driver which supplies the electromagnetic radiation, and a power supply which supplies the power to the driver.

### BRIEF DESCRIPTION OF THE DRAWINGS

FIG. 1A is a graph showing the voltage standing wave ratio (VSWR) of a lamp body of a plasma lamp as it goes through its different stages of operation according to an example embodiment;

FIG. 1B is a graph showing the peak voltage on the drain of a transistor being used as a driver for the plasma lamp due to the VSWR of the lamp body as it goes through its different states of operation according to an example embodiment;

FIG. 1C is a graph showing the DC voltage levels for the different states of operation of the plasma lamp according to an example embodiment;

FIG. 1D is a graph showing the reduction of the peak voltage on the drain of the transistor due to the VSWR of the lamp body as it goes through its different states of operation by adjusting the DC voltage with the variable voltage power supply according to an example embodiment;

FIG. 2A is a block diagram of a driver circuit of a plasma lamp with a variable voltage power supply according to an example embodiment;

FIG. 2B is a block diagram of a driver circuit of a plasma lamp with a variable voltage power supply and a side cross-section view of a lamp body with a cylindrical outer surface according to an example embodiment;

FIG. 2C is a block diagram of a driver circuit of a plasma lamp with a variable voltage power supply and a side cross-section view of a lamp body in which a bulb of the lamp is oriented to enhance an amount of collectable light according to an example embodiment;

FIG. 3A is a schematic view of an amplifier where the matching circuitry to match an output impedance of an example transistor within the driver circuit to the characteristic impedance of the lamp is implemented using discrete matching components and whose drain voltage is controlled by the variable voltage power supply according to an example embodiment;

FIG. 3B is a schematic view of an amplifier where the matching circuitry to match an output impedance of an example transistor within the driver circuit to the characteristic impedance of the lamp is implemented using discrete matching components and microstrip transmission lines and whose drain voltage is controlled by the variable voltage power supply according to an example embodiment;

FIG. 4A is a block diagram of an interconnection between a microprocessor of a plasma lamp driver and a variable voltage power supply using a serial data bus according to an example embodiment;

FIG. 4B is a block diagram of an interconnection between a microprocessor of a plasma lamp driver and a variable voltage power supply using an analog control voltage according to an alternative example embodiment;

FIGS. 5A to 5E are flow charts of a method for starting an electrodeless plasma lamp according to an example embodiment;

FIG. 6 is a flow chart of a method used for run mode operation of an electrodeless plasma lamp according to an example embodiment;

FIG. 7A is a cross-section and schematic view of a directional light source according to an example embodiment, usable with various embodiments of the control circuit and method discussed herein;

FIG. 7B shows an example lamp body used to couple power into the bulb of the directional light source according to an example embodiment;

FIG. 7C is a perspective sectional view of a rectangular prism-shaped dielectric waveguide body according to a second example embodiment, including an opening separated from a bottom recess by a layer of dielectric material.

FIG. 8 schematically depicts a single seal formed bulb, in accordance with an example embodiment, in a “round” resonant cavity;

FIG. 9 schematically depicts a double seal cylindrical bulb, in accordance with an example embodiment, in a “square” resonant cavity;

FIG. 10 shows a cross-section and schematic views of a plasma lamp, according to an example embodiment, in which a bulb of the lamp is oriented to enhance an amount of collectable light;

FIG. 11 is a perspective exploded view of a lamp body, according to an example embodiment, and a bulb positioned horizontally relative to an outer upper surface of the lamp body; and

FIG. 12 is another schematic representation of an example embodiment of an electrodeless plasma lamp.

### DETAILED DESCRIPTION

While example embodiments of the disclosed subject matter are open to various modifications and alternative constructions, the embodiments shown in the drawings will be described herein in detail. It is to be understood, however, there is no intention to limit the disclosed subject matter to the particular forms disclosed. On the contrary, it is intended that the subject matter cover all modifications, equivalences, and alternative constructions falling within the spirit and scope of the disclosed subject matter as expressed in the appended claims.

Electrodeless plasma sources are known light sources and comprise a light bulb with a plasma material, where the plasma material emits light when it is excited by electromagnetic radiation, a driver which supplies the electromagnetic radiation, and a power supply which supplies the power to the driver. The emitter portion of the electrodeless plasma source, containing the bulb, and a method to couple the electromagnetic energy to the plasma material contained in the bulb goes through several states of operation prior to achieving full light output. The stages may include pre-ignition, warm up 1, warm up 2, and full brightness or run state. At each of these states, the load presented to the source of the electromagnetic radiation changes.

Typically sources for electromagnetic radiation include solid state power amplifiers using gallium nitride (GaN), laterally diffused metal-oxide-semiconductor (LDMOS), gallium arsenide (GaAs), silicon carbide (SiC), vertical double-diffused MOS (VDMOS) or other types of transistors. Power amplifiers are designed to be operated into a fixed, known impedance (called a characteristic impedance). A typical impedance might be 50 ohms but other impedances can be used.

When a power amplifier is subjected to a load impedance other than the designed characteristic impedance, a Voltage Standing Wave (VSW) is created. A VSW creates peak voltages at the transistor or transistors. If the peak voltage exceeds the rating of the transistor, the transistor may be damaged, either partially or catastrophically. The level of the peak voltage created by the VSW is related by phase and magnitude of the load compared to the characteristic impedance, the voltage that is applied to a drain/collector of the transistor, and the forward power delivered from the power amplifier.

As mentioned previously, the load of the emitter that the power amplifier is driving changes depending on the state it is in. In order to increase power transfer, which leads to improved light intensity, the emitter's load is designed to be the same as the characteristic impedance of the power amplifier during the full brightness or run state. The other states of operation (pre-ignition, warm up 1, and warm up 2) present emitter loads that are not at the characteristic impedance of the lamp.

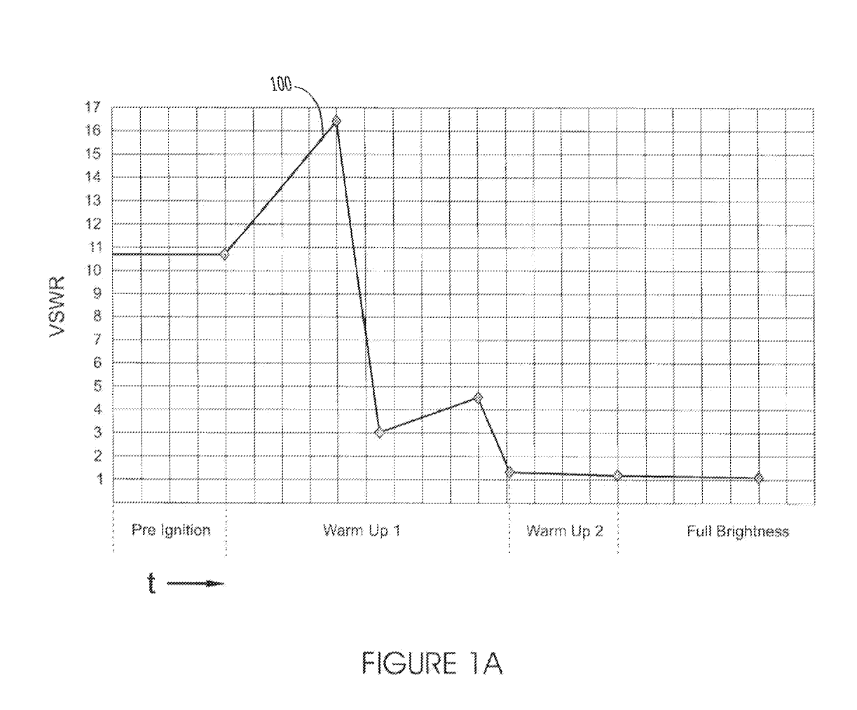

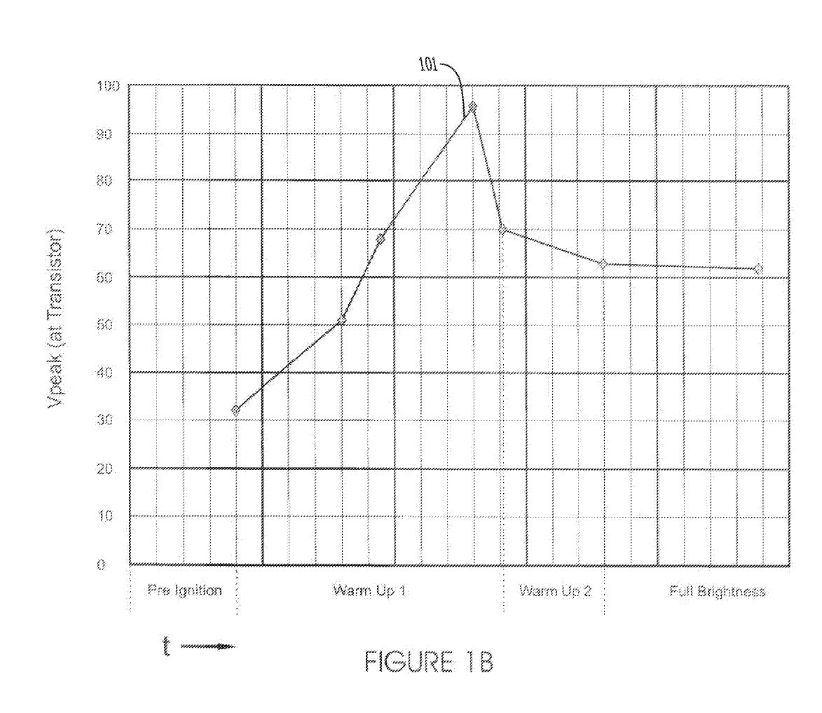

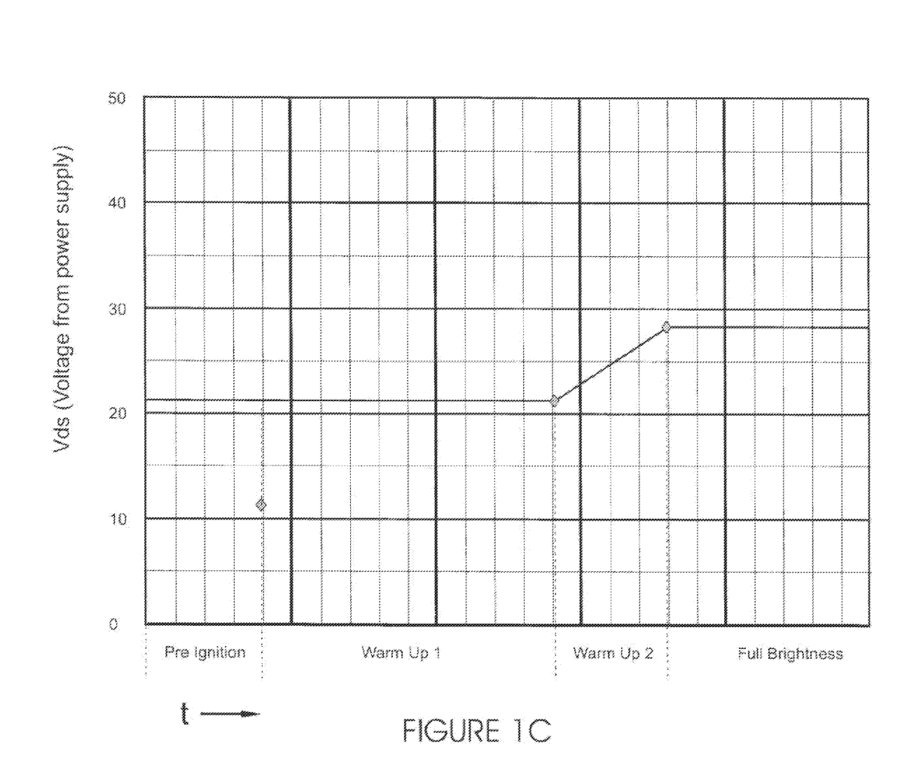

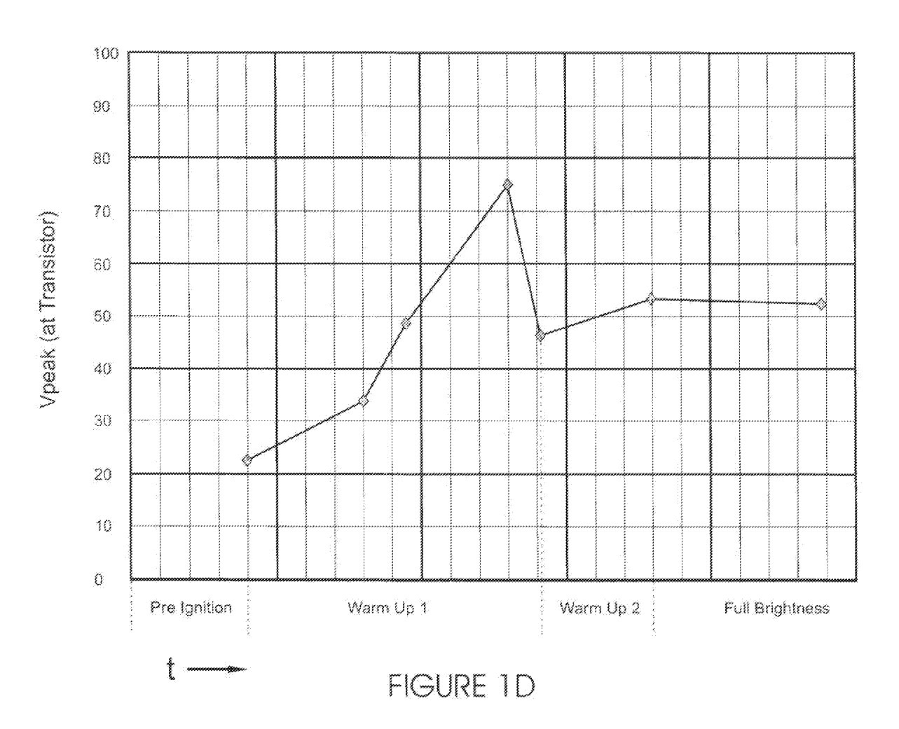

FIG. 1A is a graph showing a voltage standing wave ratio (VSWR) of a lamp body of a plasma lamp as it goes through its different stages of operation according to an example embodiment. The VSWR line 100 indicates the VWSR, which is a ratio of the maximum standing wave amplitude to the minimum standing wave. An ideal situation has a VSWR of 1 in which all the transmitted power reaches the load and there are no reflections of the power. In FIG. 1A, the VSWR line 100 peaks at nearly 17 during the warm up 1 period.

FIG. 1B is a graph showing the peak voltage (Vₚₑₐₖ) 101 on the drain of the transistor due to the VSWR of the lamp body as it goes through its different states of operation according to an example embodiment. In particular, the graph shows the peak voltages present at the device as the lamp body goes through its various states for a power amplifier operating at a DC voltage of 28 (volts (V)). As can be seen from the peak voltage 101 in FIG. 1B, peak voltages greater than 90V can be present at the transistor. Based on the transistor's vertical and lateral breakdown voltages for a device designed to operate at 28V, for example, this would cause a catastrophic failure of the transistor.

An example of a device designed to operate at 28V is the Freescale MRF5S9070NR1 (Freescale Semiconductor, Inc., Tempe, Ariz. USA), which has a vertical breakdown voltage of 68V and a lateral breakdown voltage of 85V. In LDMOS devices, the predominant catastrophic failure is due to exceeding the lateral breakdown voltage.

Several methods could be used to reduce the peak voltage. One example would be to reduce the forward power of the power amplifier during this state of operation. Although this would reduce the peak voltage, it would also reduce the power delivered to the bulb for ignition and may result in the plasma material not igniting. Another example method would be to increase the peak voltage capability of the transistor. This method would allow for higher peak voltages at the device without failure but would result in lower efficiency and gain of the device. Another example method would be to reduce the drain/collector voltage used to drive the power amplifier. In example embodiments, this method has been shown to reduce the peak voltages at the drain/collector. A potential drawback is that for the same size of transistor, with the lower drain/collector voltage, the output power is reduced. In order to achieve the equivalent output power, a larger device would need to be used. This would increase the cost of the device and would typically lead to lower efficiencies and increased difficulty in matching the transistor to the characteristic impedance.

FIG. 1C is a graph showing the DC voltage levels for the different states of operation of the plasma lamp according to an example embodiment. The DC voltage from the power supply is kept low during Pre-Ignition and Warm Up 1 phases to minimize the chance of power transistor failure due to the normally high VSWR during these phases. A typical low value may be in the range of 18 volts to 24 volts for a design that nominally runs at 28 volts in Full Brightness phase. In Warm Up 2 phase, when VSWR is typically reduced compared to the preceding phases; the DC voltage from the power supply is increased to achieve greater power transfer to the load impedance. The DC voltage remains at the high value, which in this example is 28 volts, during the Full Brightness phase while the lamp is operating at full power.

FIG. 1D is a graph showing the reduction of the peak voltage on the drain of the transistor due to the VSWR of the lamp body as it goes through its different states of operation by adjusting the DC voltage with the variable voltage power supply according to an example embodiment. Comparing FIG. 1D to FIG. 1B, it is clear that the peak voltage curve of FIG. 1D is reduced with respect to that of FIG. 1B. The peak voltage is proportional to both the VSWR and the DC voltage from the power supply. It is not practical to arbitrarily reduce the VSWR within a larger set of design constraints, such as delivering the required RF power to the load impedance. Therefore, by reducing the power supply DC voltage, the peak voltage can be reduced.

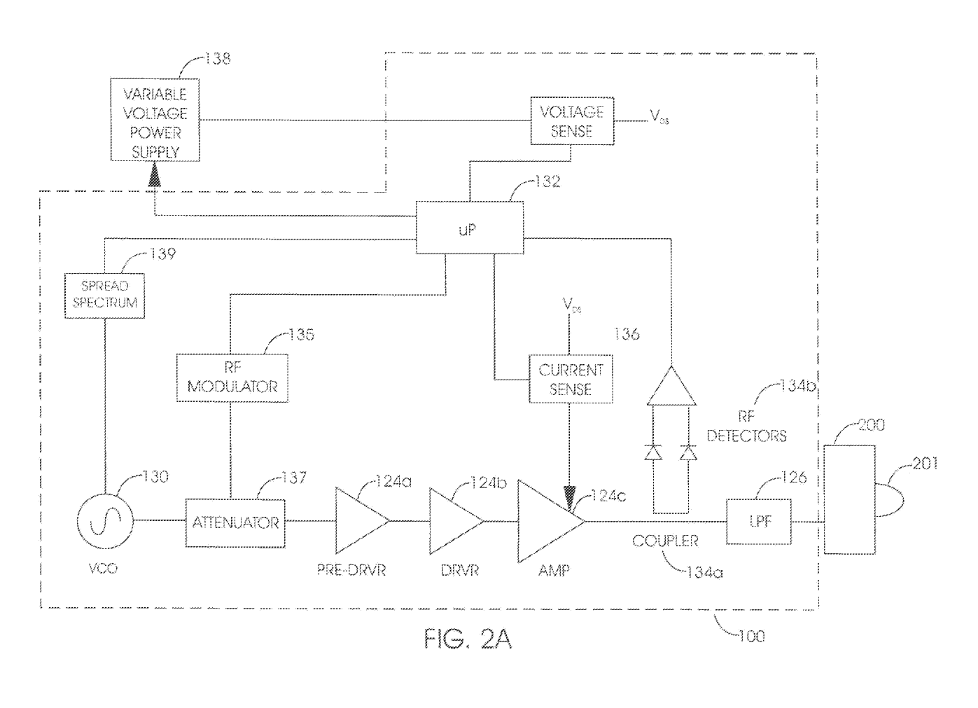

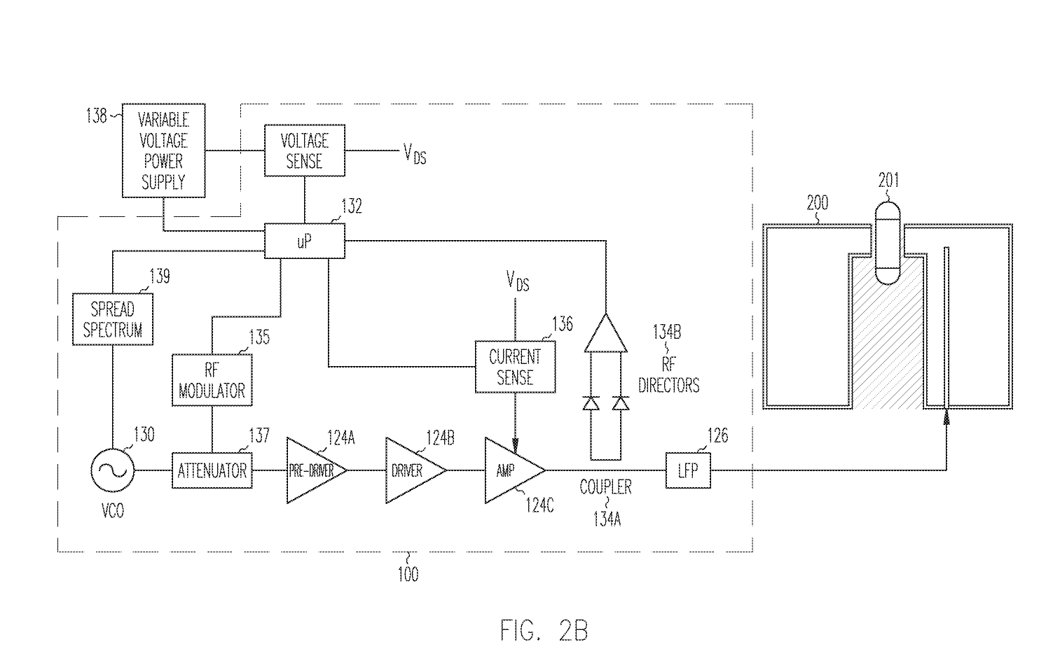

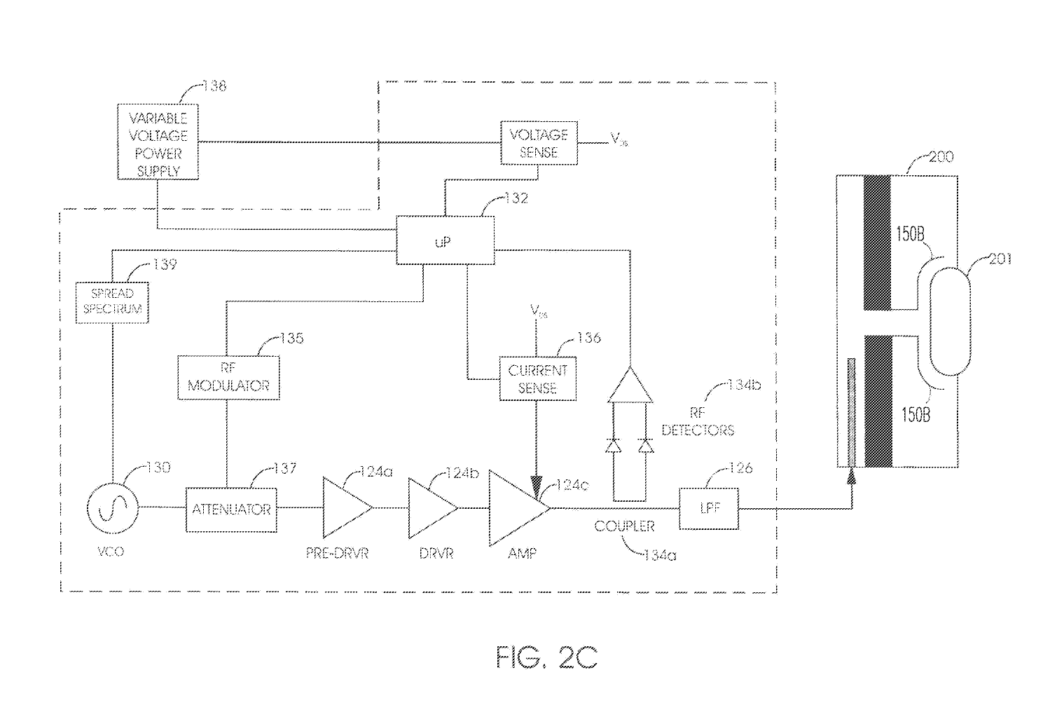

Referring now concurrently to FIG. 2A through FIG. 2C, FIG. 2A is a block diagram of a plasma lamp 200 and driver circuit 100 with a variable voltage power supply (VVPS) 138 according to an example embodiment; FIG. 2B is a block diagram of a drive circuit 100 of a plasma lamp 200 with a variable voltage power supply 138 and a side cross-section view of a lamp body 200 with a cylindrical outer surface according to an example embodiment; and FIG. 2C is a block diagram of a drive circuit 100 of a plasma lamp 200 with a variable voltage power supply 138 and a side cross-section view of a lamp body 200 in which a bulb 201 of the lamp is oriented to enhance an amount of collectable light according to an example embodiment.

As discussed in more detail with reference to various examples of plasma lamp, below, the electrodeless plasma lamp 200 includes a resonant structure having a quarter-wave resonant mode. The resonant structure has an inner conductor, an outer conductor, and a solid dielectric material between the inner conductor and the outer conductor. The electrodeless plasma lamp further includes a lamp drive circuit 100 that generates a source of radio frequency (RF) power to provide RF power to the resonant structure at about the resonant frequency for the quarter-wave resonant mode. A bulb 201 contains a fill to form a plasma when the RF power is coupled to the fill. The bulb 201 is positioned proximate to a non-conductive surface of the solid dielectric material. The variable voltage power supply 138 includes circuitry to convert AC voltage to DC voltage or DC voltage to a different DC voltage. The variable voltage power supply 138 further includes circuitry to vary the output DC voltage where the output DC voltage is varied proportionally to a control signal. Where in the control signal is either generated as a DC voltage from the plasma lamp 200 or is converted based on a digital signal from the plasma lamp 200 to a control signal.

The electrodeless plasma lamp 200 with the variable voltage power supply 138 includes a source 100 of radio frequency (RF) power. The bulb 201 contains a fill that forms a plasma when the RF power is coupled to the fill, and a dipole antenna 150B (FIG. 2C) proximate the bulb 201.

The dipole antenna 150B may comprise a first dipole arm and a second dipole arm spaced apart from the first dipole arm. The source 100 of RF power may be configured to couple the RF power to the dipole antenna 150B such that an electric field is formed between the first dipole arm and the second dipole arm. The dipole antenna 150B may be configured such that a portion of the electric field extends into the bulb 201 and the RF power is coupled from the dipole antenna 150B to the plasma. The variable voltage power supply 138 includes a means to convert AC voltage to DC voltage or DC voltage to a different DC voltage. The variable voltage power supply 138 includes circuitry to vary the output DC voltage where the output DC voltage is varied proportionally to a control signal. The control signal is either generated as a DC voltage from the plasma lamp 200 or is converted to a DC control voltage based on a digital signal from the plasma lamp 200.

With continuing reference to FIGS. 2A through 2C, a person of ordinary skill in the art, upon reading and understanding the disclosure provided herein, will recognize that the various embodiments are examples only. For instance, plasma lamps other than those specifically described may be used with other embodiments, including microwave or inductive plasma lamps. In the example of FIGS. 2A through 2C, the plasma lamp may have a lamp body 200 formed from one or more solid dielectric materials and a bulb 201 positioned adjacent to the lamp body 200. In one example embodiment, the lamp body 200 is formed from solid alumina having a relative permittivity of about 9.2. The bulb 201 contains a fill that is capable of forming a light-emitting plasma. The lamp drive circuit 100 couples radio frequency power into the lamp body 200 which, in turn, is coupled into a fill in the bulb 201 to form the light emitting plasma. In example embodiments, the lamp body 200 forms a resonant structure that contains the radio frequency power and provides it to the fill in the bulb 201.

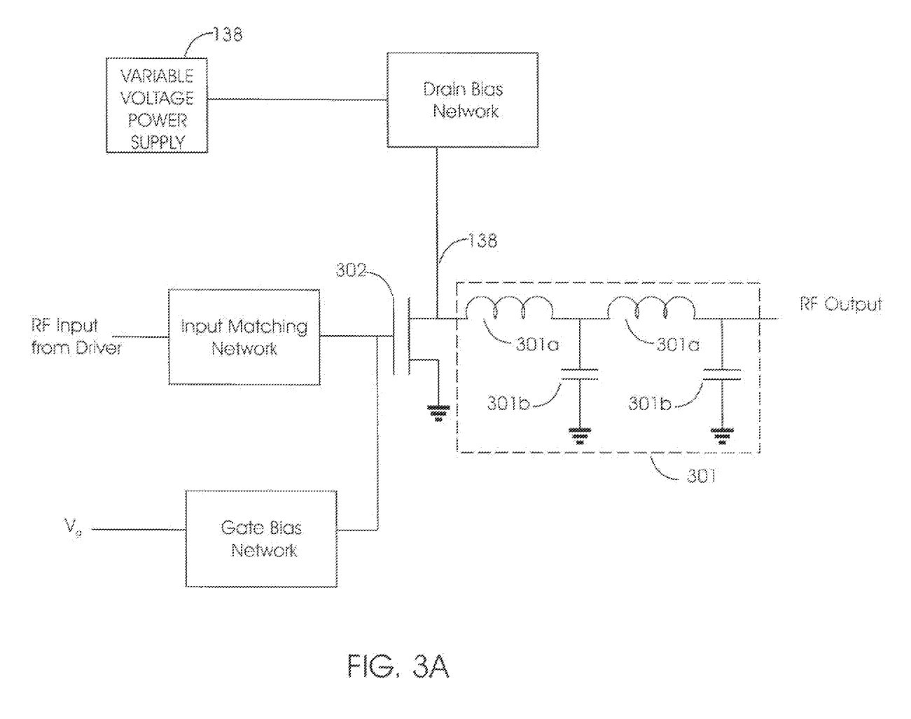

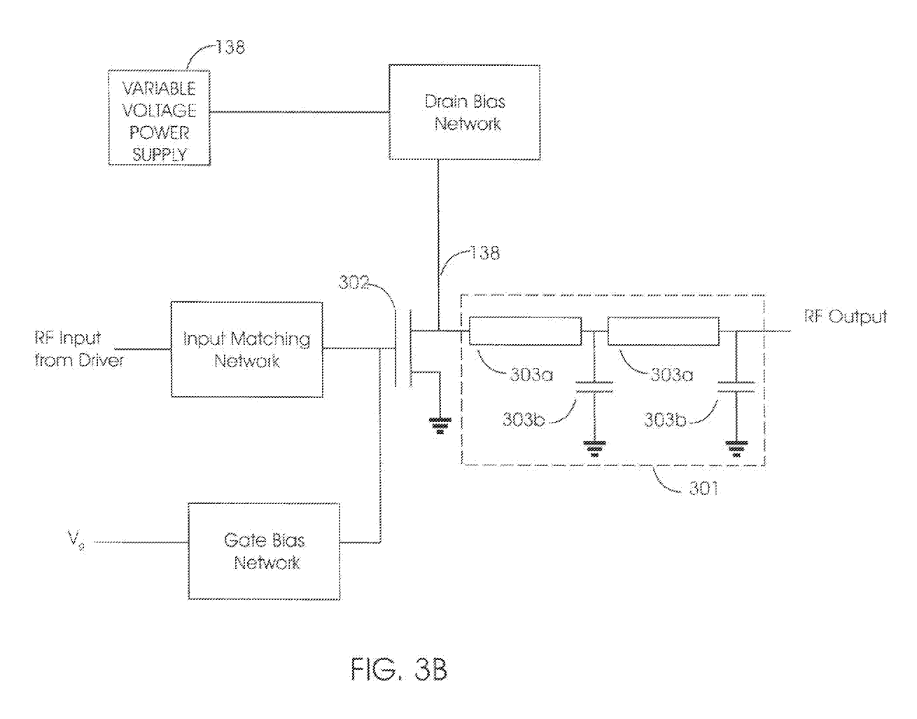

The example drive circuit 100, the variable voltage power supply 138, and operation of an example lamp will now be described with concurrent reference to FIGS. 2A, 3A, and 3B. FIGS. 3A and 3B are schematic views of an amplifier where the matching circuitry to match an output impedance of example transistors within the drive circuit 100 to the characteristic impedance of the lamp is implemented using discrete matching components and whose drain voltage is controlled by the variable voltage power supply 138, according to an example embodiment. FIGS. 3A and 3B are shown to include an impedance-matching device 301 and a high-power LDMOS transistor 302. FIG. 3A is further shown to include, for example, inductive elements 301A and capacitive elements 301B as part of the impedance-matching device 301. FIG. 3B is further shown to include, for example, transmission line elements 303A and capacitive elements 303B as part of the impedance-matching device 301.

In FIG. 2A, the drive circuit 100 includes a voltage-controlled oscillator (VCO) 130, an RF modulator 135, an attenuator 137, an amplifier 124 (comprising a pre-driver 124A, a driver 124B, and an amplifier gain-stage 124C), a low pass filter (LPF) 126, a current sensor 136, a microprocessor 132 or other controller, and a radio frequency power detector 134 (comprising a coupler 134A and RF detectors 134B).

The VCO 130 is used to provide radio frequency power to the lamp 200 at a desired frequency under control of the microprocessor 132. The radio frequency power is amplified by the amplifier 124 and provided to the lamp body 200 through the low pass filter 126. The current sensor 136 and the radio frequency power detector 134 may be used to detect the level of current and reflected power to determine a state of operation of the lamp 200. The microprocessor 132 uses the information from the current sensor 136 and the radio frequency power detector 134 to control the VCO 130, the RF modulator 135, the attenuator 137, and the VVPS 138 during startup and operation of the lamp. With reference again to FIGS. 1A through 1C, startup and operation include ignition, warm up 1, warm up 2, steady-state operation and dimming, and other control functions. In some embodiments, the microprocessor 132 may also control the gain of the amplifier 124.

The power to the lamp body 200 may be controlled by the lamp drive circuit 100 to provide a desired startup sequence for igniting the plasma. As the plasma ignites and heats up during the startup process, the impedance and operating conditions of the lamp change. In order to provide for efficient power coupling during steady-state operation of the lamp 200, in an example embodiment, the lamp drive circuit 100 is impedance matched to the steady-state load of the lamp body 200, the bulb 201, and plasma after the plasma is ignited and reaches steady-state operating conditions. The impedance matching allows power to be critically-coupled from the lamp drive circuit 100 to the lamp body 200 and plasma during steady-state operation. Critically-coupled is defined as a coupling between the lamp driver circuit 100 and the lamp body 200 in which an increased power transfer is achieved. However, in an example embodiment, the power from the lamp drive circuit 100 may be over-coupled to the lamp body 200 at ignition and during warm up of the plasma, resulting in impedances of the lamp body 200 that are not impedance matched to the lamp drive circuit 100. The difference in impedances between the lamp drive circuit 100 and the lamp body 200 produces high voltage standing waves on the lamp driver circuit 100 and on the drain of the power transistor, as discussed above with reference to FIGS. 1A through 1C.

As described with reference to FIG. 2A, the VCO 130 provides RF power at a desired frequency to the amplifier 124 (for example, a multi-stage amplifier as shown in FIG. 2A). In this example, the amplifier 124 is shown to be controlled by the microprocessor 132. In some embodiments, the amplifier gain-stage 124C may include two parallel gain-stages (the circuit trace may split into parallel lines feeding power into both amplifier gain-stages in parallel and the output from both amplifier stages may be recombined on the output side of the amplifier 124). The amplified RF power is provided to the lamp body 200 through the low pass filter 126. The current sensor 136 samples current in the lamp drive circuit 100 and provides information regarding the current to the microprocessor 132. The radio frequency power detector 134 senses reflected or reverse power from the lamp body 200 and provides this information to the microprocessor 132. The microprocessor 132 uses these inputs to control the RF modulator 135, the attenuator 137, and the VVPS 138. The microprocessor 132 also uses this information to control the frequency of the VCO 130. A spread spectrum circuit 139 between the microprocessor 132 and the VCO 130 can be used to adjust the signal to the VCO 130 to spread the frequencies over a range to reduce EMI as described below.

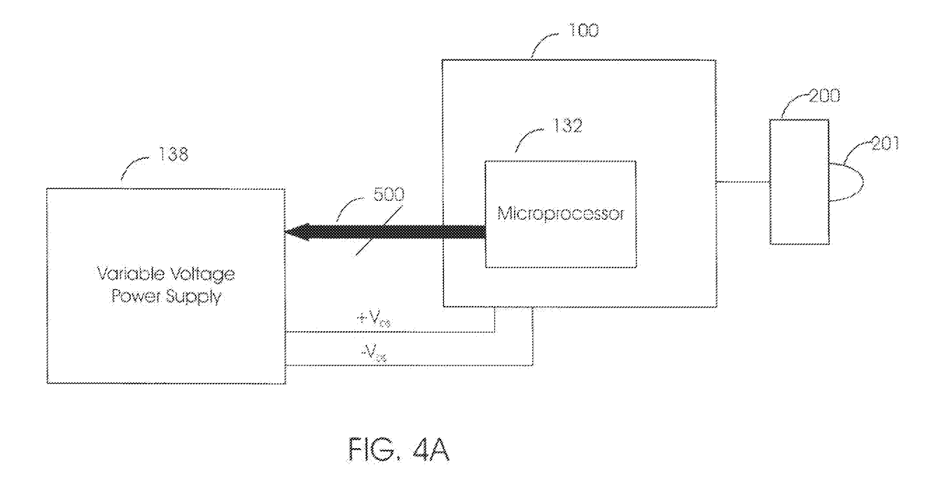

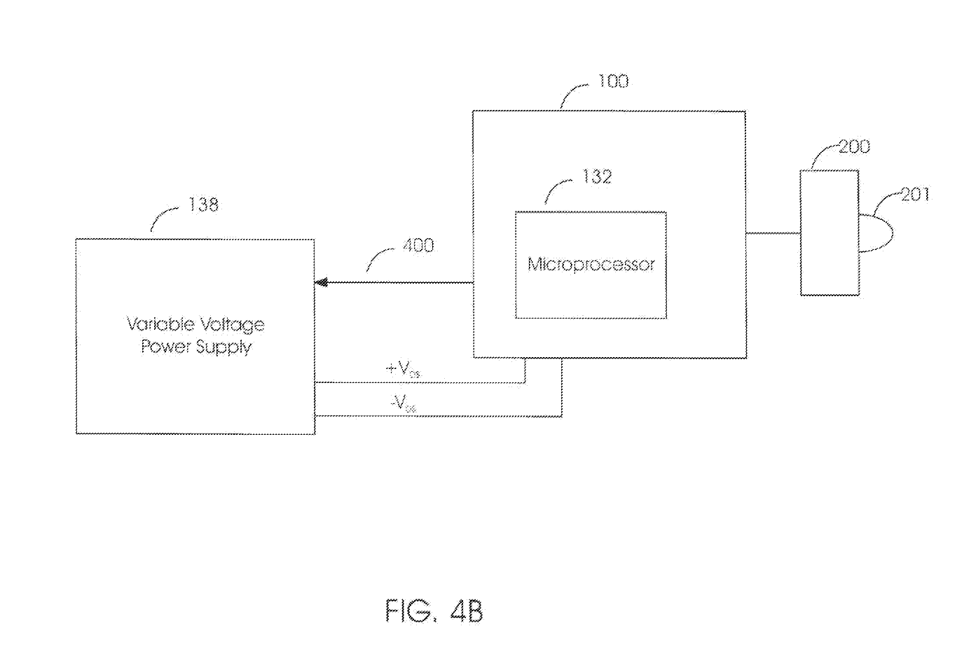

With reference now to FIGS. 2A, 4A, and 4B, the operation of the overall example drive circuit 100 for the lamp 200 during its states of operation including ignition, warm up 1, warm up 2 and run modes will now be described. FIG. 4A is a block diagram of an interconnection 500 between a microprocessor 132 of the plasma lamp 200 and the variable voltage power supply 138 using a digital control voltage on a serial data bus according to an example embodiment. FIG. 4B is a block diagram of an interconnection 400 between a microprocessor 132 of the plasma lamp 200 and the variable voltage power supply 138 using an analog control voltage according to an alternative example embodiment. In some embodiments, the interconnection may be an “Inter-Integrated Circuit” (I²C) bus or two-wire circuit bus known independently in the art. In other embodiments, the interconnection 400 may be a serial peripheral interface (SPI) bus. In other embodiments, the interconnection 400 may be a digital control voltage on a parallel bus.

In one embodiment, the voltage to the lamp drive circuit 100 from the VVPS 138 for the run state can be 28V. During ignition, the microprocessor 132 sets the voltage from the VVPS 138 by sending a control signal which adjusts the voltage from the VVPS 138 to a desired level, typically between 21 and 24V DC. In one example embodiment, the control voltage on the interconnection 400 is an analog voltage that is proportional to the desired output voltage of the VVPS 138. In another embodiment, the control voltage on the interconnection 500 is a serial digital voltage whose bit sequence represents the desired output voltage of the VVPS 138.

The microprocessor 132 then ramps the VCO 130 through a series of frequencies until ignition is detected by detecting a sudden drop in reflected power from the radio frequency power detector 134. In an example embodiment, the microprocessor 132 also adjusts the RF modulator 135 and the attenuator 137 based on the current sensor 136 to maintain the desired current level in the circuit. Once a predetermined drop in reflected power level is detected indicating ignition (e.g., a reflected power reference level is reached), the microprocessor 132 enters warm up 1 state (a first warm up state). During warm up 1, the microprocessor 132 ramps the frequency of the VCO 130 through a pre-defined range and keeps track of the reflected power from the detector at each frequency. The microprocessor 132 then adjusts the frequency to the level determined to have the lowest reflected power.

The lamp then enters into the warm up 2 state (a second warm up state) where the microprocessor 132 increases the voltage from the VVPS 138 by sending a control signal which ramps the voltage from the VVPS 138 to 28V over a time period of, for example, about 3 seconds to 5 seconds. Once the detector senses reflected power below a pre-determined threshold level indicating completion of warm up 2, the microprocessor 132 enters run state.

In the run state, the microprocessor 132 adjusts the frequency up and down in small increments (e.g., perhaps 0.01 percent of the RF frequency) to determine whether the frequency should be adjusted to achieve a target reflected power level with the current level reduced. For example, the microprocessor 132 increments the frequency up and checks to see if the reflected power level is greater or less than the previously saved level. If the reflected power is lower than the currently saved level, the microprocessor 132 saves the new reflected power level and then repeats the process by incrementing the frequency up again and checking the value of the new reflected power level and comparing it to the saved reflected power level. This iterative process continues until the new reflected power level is equal to or greater than the saved reflected power level. If the microprocessor 132 increments the frequency up and the new reflected power level is higher than the saved value, the microprocessor 132 will return to the saved VCO frequency and then increment the frequency down and repeat the process as described above (except for decreasing the frequency each time) until the value of the new reflected power is equal to or higher than the saved reflected power.

In some embodiments, ripple current can be detected in the lamp drive circuit 100 instead of or in addition to reflected power. When the frequency of the VCO 130 is modulated (for example, when the spread spectrum circuit 139 is used) and the circuit is off from the resonance frequency, a ripple current results in some example embodiments. Changes in current based on frequency increase as the frequency moves away from the resonant frequency. This current change causes a ripple when the frequency is spread by the spread spectrum circuit 139. As discussed above, the VCO 130 can be incremented through ranges to find a frequency resulting in the lowest ripple current and to compare the ripple current against pre-determined threshold values indicating ignition, warm up 1 and warm up 2, and run state.

In example embodiments, the ripple current may be used to determine and adjust the operating condition of the lamp instead of (or in addition to) RF power levels and/or a photodetector. In some cases, ripple current may have a better correlation to some lamp operating conditions to be detected by the lamp drive circuit 100 and reverse power may have a better correlation to other lamp operating conditions to be detected by the lamp drive circuit 100. In this case, ripple current and reflected power could each be detected and used when appropriate to determine lamp operating conditions to adjust the operation of the lamp 200. Lamp operating conditions to be detected by the lamp drive circuit 100 (and which may result in the microprocessor 132 adjusting the operation of the lamp drive circuit 100) may include, for example, ignition, warm up 1, warm up 2, and run modes, failure modes (for example, where the lamp 200 extinguishes after ignition without the lamp 200 being turned off), and brightness adjustment.

In various example embodiments, the lamp 200 can be dimmed by controlling the output of the VVPS 138. The power may be reduced by reducing the voltage from the VVPS 138 to achieve dimming. For example, if the VVPS 138 output is reduced to 20 V from 28 V, the power to the lamp body 200 will be cut in half (resulting in a dimming of the lamp).

This type of dimming by reducing the output from the VVPS 138 may be advantageous over dimming by adjusting the amplitude of the input signal to the amplifier 124 in some embodiments, because the amplifier 124 can be kept in a more efficient operating range when power is applied. For example, when the voltage is reduced, the power delivered to the emitter is reduced but the amplifier 124 remains closer to peak power and/or saturation rather than operating the amplifier 124 at lower gain compression and efficiency for dimming. The saturated power is proportional to the square of the DC voltage applied to the amplifier 124. Therefore, lower DC voltage reduces RF power which in turn produces dimming of the light.

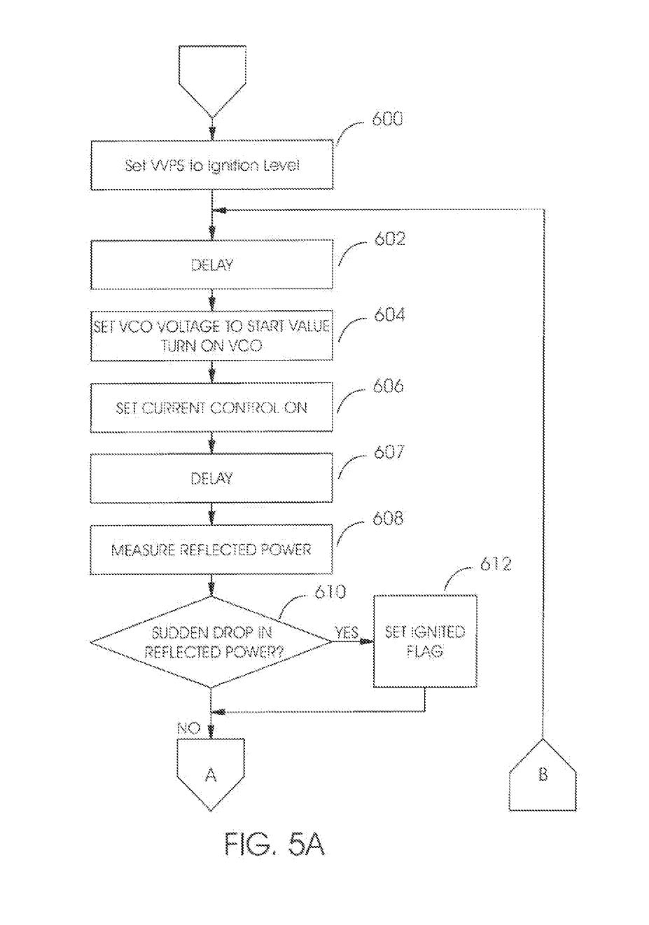

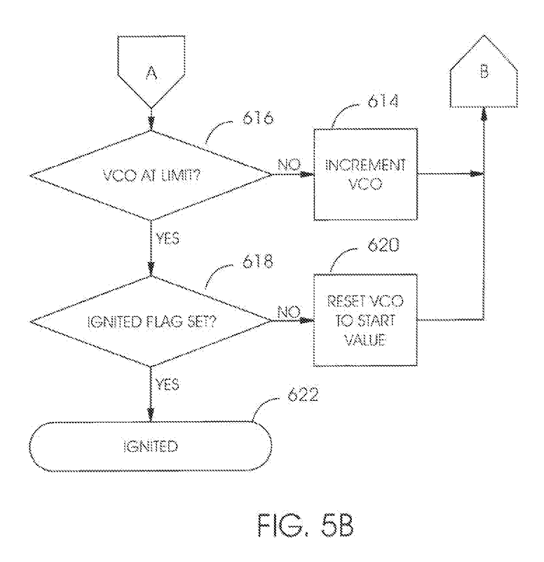

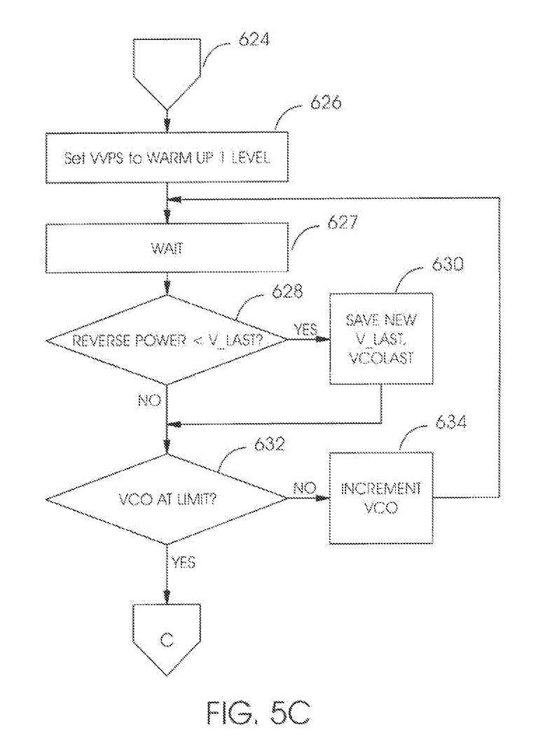

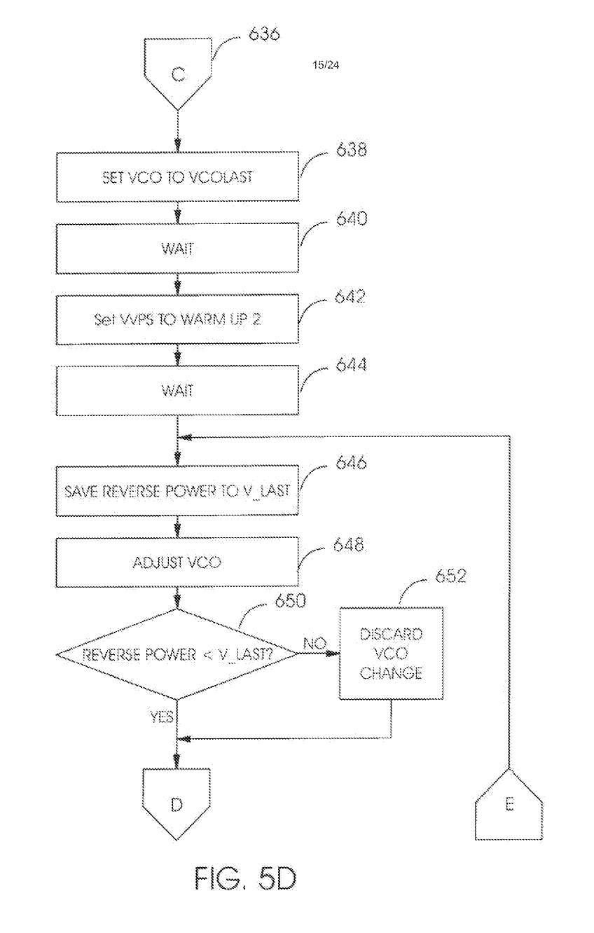

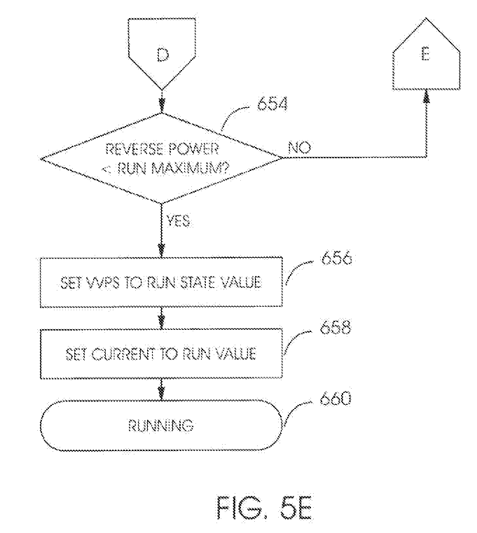

The operation of an example lamp and the lamp drive circuit 100 during startup will now be described with reference to FIGS. 5A through 5E and with continuing reference to FIG. 2A. FIGS. 5A to 5E are flow charts of a method for starting an electrodeless plasma lamp according to an example embodiment. Various start and threshold values used by the microprocessor 132 to control the lamp may be determined empirically in advance when the lamp is tested and configured. These values may be used for the various predetermined values discussed herein and may be programmed into the microprocessor 132 and associated memory ahead of time and used as described below.

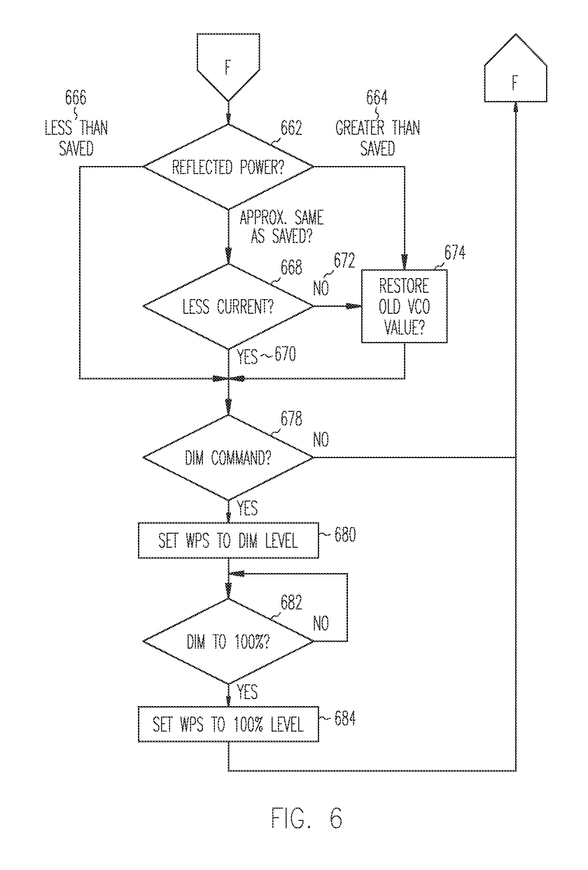

The examples described below and in FIGS. 5A to 5E (as well as FIG. 6, discussed below) use reflected or reverse power to determine lamp operating conditions. In alternative embodiments, ripple current or light detected from a photodetector may be used or other detected conditions in the lamp 200 or the lamp drive circuit 100 may be used (for example, forward power or net power or other conditions). In some embodiments, a combination of detectors may be used (for example, different threshold values during startup or run mode may be determined using different techniques such as reflected power, ripple current, or level of light detected).

In the example shown in FIGS. 5A to 5E, for ignition mode, the microprocessor 132 sets internal flags in memory (not shown) to indicate that the lamp 200 has not started. The microprocessor 132 sets the output voltage of the VVPS 138 to the ignition state level (see block 600) by sending a command to the VVPS 138. A brief delay period, at block 602, allows the lamp to adjust to the output from the VVPS 138. The time period for the delay may be determined based on operating characteristics of the lamp. The microprocessor 132 sets the control voltage on the VCO 130 to the desired level for startup and turns the VCO on (see block 604). As indicated in FIG. 5A, the microprocessor 132 sets “current control” to on (see block 606), which prevents the lamp drive circuit 100 from exceeding a maximum current (as determined by the current sensor 136). Another brief delay period, at block 607, allows the lamp to adjust to the new output. The microprocessor 132 measures the reflected power (see block 608) and determines whether the value has dropped below a predetermined threshold value, indicating ignition of the lamp (see decision block 610). Upon ignition, the microprocessor 132 sets an ignited flag in memory (see block 612) to indicate that the fill in the bulb 201 has ignited. Once the set ignited flag operation has been completed at block 612, or if a determination is made at block 610 that there is no sudden drop in reflected power, the method continues at FIG. 5B.

As indicated by reference to FIG. 5B, a determination is made whether the VCO 130 is at a limit of operation. If not, the microprocessor 132 increments the VCO 130 over a range of frequencies (see block 614). After the VCO 130 frequency is incremented, the method continues again at FIG. 5A. In one example embodiment, the frequency of the VCO 130 is incremented over a range of about 50 MHz in steps of about 60 kHz (by adjusting the control voltage on the VCO 130 in steps of about 3 mV). In other example embodiments, the frequency sweep may cover a range of about 10 MHz to 100 MHz or any range subsumed therein in steps of 10 kHz to 1 MHz or any range subsumed therein. These are examples only and other embodiments may use other ranges. This increment of frequencies continues until the VCO 130 has stepped through the frequency range (see block 616) and a determination is made at block 618 that the lamp has ignited (indicated by an ignited flag as shown at block 622). If a determination is made that the lamp is not ignited at block 618, the VCO 130 is reset to the start value and the method continues again at FIG. 5A.

Referring now to FIG. 5C, the method continues when a determination is made that the lamp is entering the warm up 1 state (see block 624). The microprocessor 132 then adjusts the current in the lamp drive circuit 100 (as sensed by the current sensor 136) to a predetermined level desired for warm up 1. The microprocessor 132 sends a control signal to the VVPS 138 which causes the voltage from the VVPS 138 to be adjusted to the warm up 1 state level (see block 626). The VCO 130 is set to its start value and stored by the microprocessor 132 in memory as VCOlast. The microprocessor 132 also reads the reverse power and saves the value as V_last. A brief wait period, at block 627, allows the lamp to adjust to the new output from the VVPS 138.

The microprocessor 132 then increments the VCO 130 over a range of frequencies (for example, in a similar manner to that described above, with reference to FIG. 5B). The microprocessor 132 reads the reverse power after each increment (see decision block 628). If the reading is lower than the prior value (V_last), the microprocessor 132 saves the value read by the power detector as V_last and saves the level of the VCO 130 as VCOlast (see block 630). This process continues until the VCO 130 has been incremented through the full range of warm up frequencies and reaches the upper limit of the range (see decision block 632). The VCO 130 is then set to VCOlast and the reverse power is read and saved as V_last. Once the VCO 130 is at its limit of operation as determined at block 632, the method continues at FIG. 5D.

Referring now to FIG. 5D, the lamp then enters warm up 2 state (see block 636) VCO is set to VCOlast at block 638. A brief wait period, at block 640, allows the lamp to adjust to the new output. The microprocessor 132 sends a control signal to the VVPS 138 which causes the voltage from the VVPS 138 to increase from the warm up 1 level to the warm up 2 level over a time frame of about 1 second to 5 seconds (see block 642). Another brief wait period, at block 644, allows the lamp to adjust to the new output. Reverse power is saved to Vlast at block 646. The microprocessor 132 then adjusts the VCO in small increments (see block 648) to see if the adjustment decreases reflected power. At decision block 648, the microprocessor evaluates whether the VCO adjustment from block 648 reduced the reflected power. If reflected power was not reduced, then the microprocessor continues to block 652, which reverts the VCO to its old value prior to block 648. If the reflected power was reduced, then block 652 is skipped. In decision block 654, the reflector power value is evaluated against a threshold to determine if the lamp has entered Run State. If not, then the loop returns to block 646 to continue optimizing VCO until decision block 654 evaluates positive. If the reflected power is less than the threshold, then the lamp is determined to be in the Run State, with load impedance that produces typically-low VSWR characteristic of Run State. The process continues to block 656, where the microprocessor sets the VVPS to the Run State Value, which may be 28 volts in certain embodiments. Continuing to block 658, the microprocessor sets the target run current for the lamp to the Run State value that corresponds to the designed value of power delivery to the lamp.

The operation of the lamp in run mode will now be described, by way of example, with continuing reference to FIG. 2A through FIG. 2C and additional reference to FIG. 6. FIG. 6 is a flow chart of a method used for run mode and dimming operation of an electrodeless plasma lamp according to an example embodiment. During run mode, the microprocessor 132 checks several preliminary status checks or conditions to see if there is a change in the mode of the lamp. For example, the microprocessor 132 may check that the level of reflected power is below the predetermined threshold level required for the run mode (which may indicate a failure condition). The microprocessor 132 may also check for a stop command to shut off the lamp. The microprocessor 132 may also check for commands to change the brightness of the lamp. The microprocessor 132 may also check whether the lamp is operating in a low brightness condition (for example, less than 20% brightness) and, in some embodiments, may not further adjust the VCO 130 to optimize based on reverse power in low brightness modes.

After the preliminary status checks, the microprocessor 132 may change the frequency of the VCO 130 in small increments for optimization. As indicated with reference to FIG. 6, the level of reflected power may be a primary measure used for optimization (see decision block 662). If a determination is made that the reflected power is greater than the saved value of the reflected power, at operation 664, due to the change in the VCO 130, then the change in the VCO 130 is discarded and the old value of the VCO is restored (as shown at 664). The loop then continues to the decision block 678 to determine whether a dim command is present and, if not, continues back to make a determination with reference to the reflected power at block 662. Thus, the loop is repeated, except that the change in the VCO 130 will be made in the opposite direction the next time through the loop if the change was discarded on the previous loop iteration. Otherwise, the VCO change will continue in the same direction, as described below.

If the reflected power decreases compared with the save value of reflected power (as shown at operation 666) due to the change in the VCO 130, then the VCO change is maintained and the loop is repeated (and the next VCO change will be made in the same direction since it reduced reflected power). If the reflected power is approximately the same (e.g., within some predetermined tolerance level such as 3% to 5% of the voltage level) as the prior value, then the current level is checked (see decision block 668). If the current level is lower than the prior level, then the change in the VCO 130 is maintained and the VCO 130 continues to be adjusted in the same direction (as shown at operation 670). If the current level is not lower, then the VCO change is discarded (see block 674) and the old VCO value is restored. The VCO 130 is adjusted in the opposite direction the next time through the loop.

During run mode, the microprocessor 132 checks for a dim command from the analog 0 V to 10 V dimming control or the digital command input (see decision block 678). If the microprocessor 132 does not receive a dim command, the process continues at block 662. If the microprocessor 132 receives a dim command, the microprocessor 132 suspends the optimization routine. The microprocessor 132 will determine the dim level based on the analog voltage input or the digital bit sequence. The microprocessor 132 then sends a control signal to the VVPS 138 that reduces the voltage from the VVPS 138 to a level to achieve the required dim level (see block 680).

As an example, the microprocessor 132 receives a command to dim the lamp to about 60%. The microprocessor 132 sends a control signal to the VVPS 138 to reduce the voltage from the VVPS to about 23 V in one embodiment. The microprocessor 132 continues to check for dim commands to change the level of brightness if requested. If the microprocessor 132 receives a dim command to go to about 100% brightness (see decision block 682), the microprocessor 132 sets the VVPS 138 output to the 100% level (see block 684) and then resumes the optimization routine at block 662.

In some embodiments and with continuing reference to FIG. 2A, the lamp drive circuit 100 may include a spread spectrum mode to reduce electro-magnetic interference (EMI). Spread spectrum is turned on by the spread spectrum controller 139. When spread spectrum is turned on, a signal to the VCO 130 is modulated to spread the power provided by the lamp drive circuit 100 over a larger bandwidth. The large bandwidth can reduce EMI at any one frequency and thereby help with compliance with, for example, the Federal Communications Commission (FCC, a United States agency) or other regulatory agencies that govern regulations regarding EMI in other countries. In example embodiments, a degree of spectral spreading may be from about 0.1% to 30% or any range included therein. In other example embodiments, a degree of spectral spreading may be from about 0.2% to 1%. In example embodiments, modulation of the VCO 130 can be provided at a level that is effective in reducing EMI without any significant impact on the plasma in the bulb 201.

### Examples of Lamp Bodies Usable with the Various Control Circuits and Methods

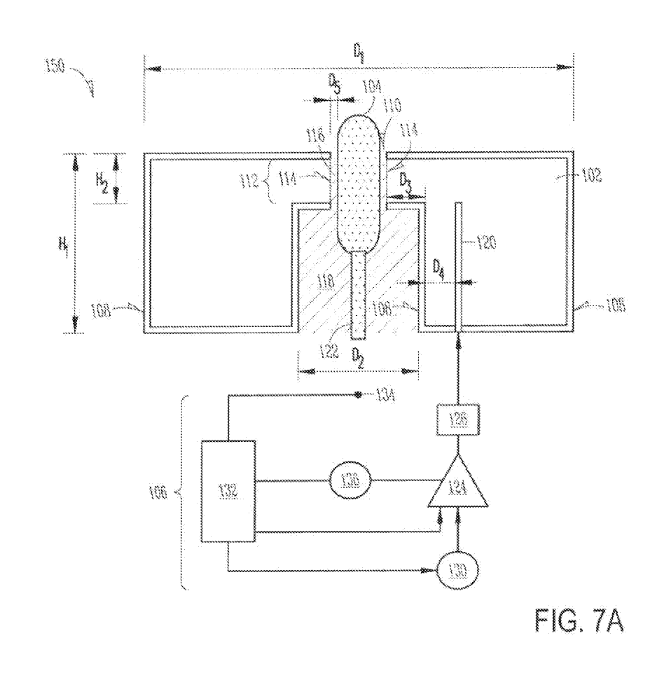

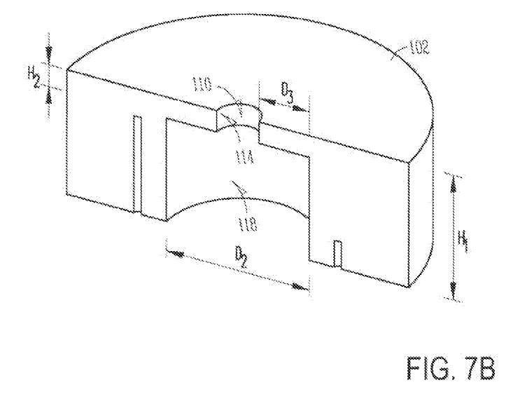

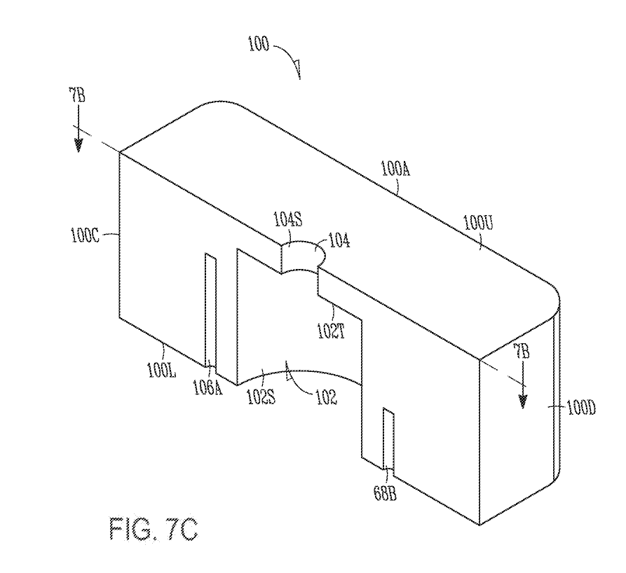

FIG. 7A is a cross-section and schematic view of a directional light source 150 according to another example embodiment. In example embodiments, the directional light source 150 may be used in any of the circuits and methods discussed herein. In the example of FIG. 7A, the directional light source may have a lamp body 102 formed from one or more solid dielectric materials and a bulb 104 positioned adjacent to the lamp body 102. The lamp body may have various geometries, such as a circular cross-section as indicated with reference to FIG. 7B.

With continuing reference to FIG. 7A, the bulb 104 contains a fill that is capable of forming a light emitting plasma (not shown). A lamp drive circuit 106 couples radio frequency (RF) power into the lamp body 102 which, in turn, is coupled into the fill in the bulb 104 to form the light emitting plasma. In example embodiments, the radio frequency power may be provided at or near a frequency that resonates within the lamp body 102. This is an example only and some embodiments may use a different directional light source.

The directional light source 150 has a drive probe 120 inserted into the lamp body 102 to provide the radio frequency power to the lamp body 102. The lamp drive circuit 106 including a power supply, such as an amplifier 124, may be coupled to the drive probe 120 to provide the radio frequency power. The amplifier 124 may be coupled to the drive probe 120 through a matching network 126 to provide impedance matching. In an example embodiment, the lamp drive circuit 106 is matched to the load (formed by the lamp body 102, the bulb 104, and plasma) for the steady state operating conditions of the lamp. The lamp drive circuit 106 is matched to the load at the drive probe 120 using the matching network 126.

The lamp body 102 defines a dimension along the optical axis from the light emitting area to the back of the lamp. In an example embodiment of the disclosed subject matter, the lamp body 102 is designed to minimize this dimension and thereby reduce an overall length of the optical system.

In example embodiments, the radio frequency power may be provided at a frequency in the range of between about 50 MHz and about 10 GHz or any range subsumed therein. The radio frequency power may be provided to the drive probe 120 at or near a resonant frequency for the lamp body 102. The frequency may be selected based on the dimensions, shape, and relative permittivity of the lamp body 102 to provide resonance in the lamp body 102. In example embodiments, the frequency is selected for a fundamental resonant mode of the lamp body 102, although higher order modes may also be used in some embodiments.

In some examples, the bulb 104 may be quartz, sapphire, ceramic, or another desired bulb material. A shape of the bulb 104 may be cylindrical, pill shaped, spherical, or another desired shape. In some embodiments, a layer of material 116, such as, for example, alumina powder, may be placed between the bulb 104 and the dielectric material of the lamp body 102 to manage thermal properties of the directional light source 150.

In some embodiments, the bulb 104 may have a tail 122 extending from one end of the bulb 104. In some example embodiments, the tail 122 may be used as a light pipe to sense a level of light in the bulb 104. The sensing of the light level may be used to determine ignition, peak brightness, or other state information regarding the bulb 104. Light detected through the tail 122 can also be used by the lamp drive circuit 106 for dimming and other control functions of the bulb 104. For example, as shown in FIG. 7A, the tail 122 extends from the bulb 104 to the back of the lamp proximate to a photodiode 134 or other photosensor. The photodiode 134 can sense light from the bulb 104 through the tail 122. The level of light can then be used by the lamp drive circuit 106 to control the lamp. The back of the lamp can be enclosed by a cover to avoid or minimize interference from external light from the surrounding environment. This isolates the region where light is detected by the photodiode 134 and helps avoid interference that might be present if light is detected from the front of the lamp.

In example embodiments, the bulb 104 may have an interior width or diameter in a range between about 2 mm and 30 mm or any range subsumed therein, a wall thickness in a range between about 0.5 mm and 4 mm or any range subsumed therein, and an interior length of between about 2 mm and 40 mm or any range subsumed therein. In example embodiments, an interior volume of the bulb 104 may range from 10 mm³ to 750 mm³ or any range subsumed therein. In some embodiments, the bulb volume is less than about 100 mm³. In example embodiments, power is provided during steady state operation at between about 150 to 200 watts, resulting in a power density in the range of about 1.5 watts per mm³ to 2 watts per mm³ (1500 to 2000 watts per cm³) or any range subsumed therein. In this example embodiment, the interior surface area of the bulb 104 is about 55.3 mm² (0.553 cm²) and the wall loading (power over interior surface area) is in the range of about 2.71 watts per mm² to 3.62 watts per mm² (271 to 362 watts per cm²) or any range subsumed therein. In some embodiments, the wall loading (power over interior surface area) may be 1 watt per mm² (100 watts per cm²) or more. These dimensions are examples only and other embodiments may use bulbs having different dimensions. For example, some embodiments may use power levels during steady state operation of 400 watts to 1 kilowatt or more, depending upon the target application. Referring to the bulb dimensions above and accounting for the fact that the lamp body 102 acts with the bulb 104 to create a forward direction light pattern, calculation of the nominal Etendue of the source as shown below.

Etendue is approximately equal to π times A, where A is the surface area of the outer surface of the bulb 104. Table 1, below, shows the Etendue for a variety of bulb outer diameters.

TABLE 1
Nominal Etendue for Sources with Protruding Bulbs

| | | | | | | |
|---|---|---|---|---|---|---|
| Bulb Radius | 2 | 2.5 | 3 | 3.5 | 4 | 5 |
| Bulb Protrusion | 3 | 3.5 | 4 | 4.5 | 5 | 6 |
| Nominal Etendue | 118 | 173 | 237 | 311 | 395 | 592 |

This example construction provides a light source with the Etendue needed for many beam projection systems including those with a low beam angle.

FIG. 7C is a perspective sectional view of a rectangular prism-shaped waveguide body 60 according to an example embodiment. The waveguide body 60 includes dielectric material having a dielectric constant greater than about 2, for example, alumina. In some example embodiments, the dielectric material may have a dielectric constant in the range of from 2 to 10 or any range subsumed therein, or a dielectric constant in the range from 2 to 20 or any range subsumed therein, or a dielectric constant in the range from 2 to 100 or any range subsumed therein, or an even higher dielectric constant. In some example embodiments, the body 60 may include more than one such dielectric material resulting in an effective dielectric constant for the body 60 within any of the ranges described above. Body 60 has opposed planar first and second outer surfaces 60A, 60B (not shown), respectively, orthogonal to opposed planar third and fourth outer surfaces 60C, 60D. Body 60 further has a planar upper surface 60U from which depends downwardly an opening 62 for receiving a bulb, determined by a circumferential surface 62S and a planar bottom surface 62B, and a planar lower surface 60L from which depends upwardly a recess 64 determined by a circumferential surface 64S and a planar top surface 64T. A layer 66 of dielectric material separates chamber bottom surface 62B from recess top surface 64T. Surfaces 62S and 64S are cylindrical; however, other symmetric shapes, such as square or rectangular prisms, and asymmetric shapes may be used. The axis of symmetry of body 60 coincides with that of opening 62 and recess 64; however, body configurations with offset axes also are feasible. Surfaces 60A, 60B, 60C, 60D, and/or 60U and 60L may be coated with an electrically conductive coating, such as silver paint or other metallic coating as described above, as may surfaces 62S and 62B of opening 62 and surfaces 64S and 64T of recess 64. At least some of the plasma bulbs discussed herein may be positioned within opening 62. The plasma bulb may have an outer surface whose contour matches that of surface 62S and be separated from the surface 62S by a layer of heat-sintered alumina powder or adhesive. The layer may be used to optimize thermal conductivity between the bulb surface and the waveguide body 60. A first and a second probe may be positioned, respectively, within openings 68A, 68B extending from surface 60L into body 60, on opposite sides of recess 64. In some example embodiments having a body such as body 60, at least one additional probe may be positioned in the body 60.

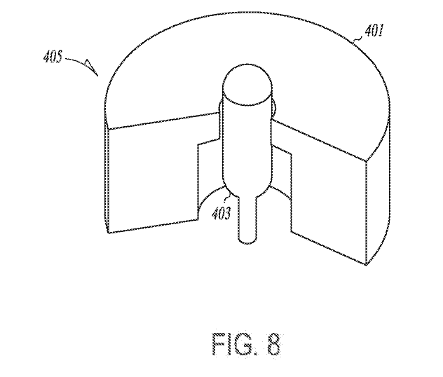

FIG. 8 schematically depicts a single seal formed bulb 403, in accordance with an example embodiment, in a “round” resonant cavity 405. In the example of FIG. 8, the plasma lamp may have a lamp body 401 formed from one or more solid dielectric materials and a bulb 403 positioned proximate or adjacent to the lamp body 401. In this example embodiment, the bulb 403 is a cylindrical single seal type. The bulb 403 contains a fill that is capable of forming a light emitting plasma. A lamp drive circuit, such as one of those described elsewhere in this disclosure, couples radio frequency power into the lamp body 401 that, in turn, is coupled into the fill in the bulb 403 to form the light emitting plasma. In example embodiments, the lamp body 401 forms a waveguide that contains and guides the radio frequency power. In example embodiments, the radio frequency power may be provided at or near a frequency that resonates within the lamp body 401. This is an example only and some embodiments may use a different electrodeless plasma lamp, such as a capacitively or inductively coupled plasma lamp, or other high intensity discharge lamp.

The example plasma lamp has a drive probe (not shown) inserted into the lamp body 401 to provide radio frequency power to the lamp body 401. A lamp drive circuit (not shown) including a power supply, such as an amplifier, may be coupled to the drive probe to provide the radio frequency power. The amplifier may be coupled to the drive probe through a matching network to provide impedance matching. In an example embodiment, the lamp drive circuit is matched to the load (formed by the lamp body, bulb, and plasma) for the steady state operating conditions of the lamp. The lamp drive circuit is matched to the load at the drive probe using a matching network (not shown).

In example embodiments, radio frequency power may be provided at a frequency in the range of between about 50 MHz and about 10 GHz or any range subsumed therein. The radio frequency power may be provided to drive probe at or near a resonant frequency for the lamp body 401. The frequency may be selected based on the dimensions, shape, and relative permittivity of the lamp body 401 to provide resonance in the lamp body 401. In example embodiments, the frequency is selected for a fundamental resonant mode of the lamp body 401, although higher order modes may also be used in some embodiments. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the electrodeless plasma lamp according to example embodiments may be used in entertainment lighting or architectural lighting or other lighting applications. In particular examples, the lamp is used in moving head entertainment fixtures, fixed spot fixtures, architectural lighting fixtures or event lighting fixtures. Example embodiments may also be used in street and area lighting and other lighting applications.

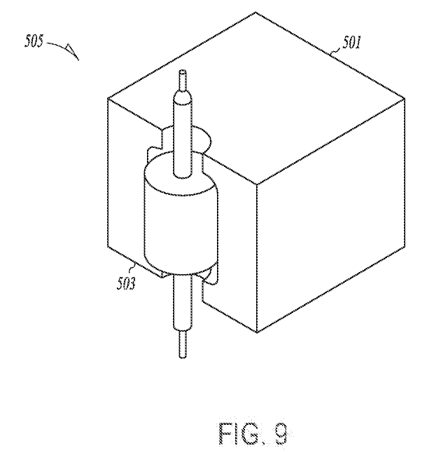

FIG. 9 schematically depicts a double seal cylindrical bulb, in accordance with an example embodiment, in a “square” resonant cavity. In the example of FIG. 9, the plasma lamp may have a lamp body 501 formed from one or more solid dielectric materials and a bulb 503 positioned adjacent to the lamp body 501. In this example embodiment, the bulb 503 is a cylindrical double seal type.

The bulb 503 contains a fill that is capable of forming a light emitting plasma. A lamp drive circuit, as disclosed elsewhere herein, couples radio frequency power into the lamp body 501 that, in turn, is coupled into the fill in the bulb 503 to form the light emitting plasma. In example embodiments, the lamp body 501 forms a waveguide that contains and guides the radio frequency power. In example embodiments, the radio frequency power may be provided at or near a frequency that resonates within the lamp body 501. This is an example only and some embodiments may use a different electrodeless plasma lamp, such as a capacitively or inductively coupled plasma lamp, or other high intensity discharge lamp.

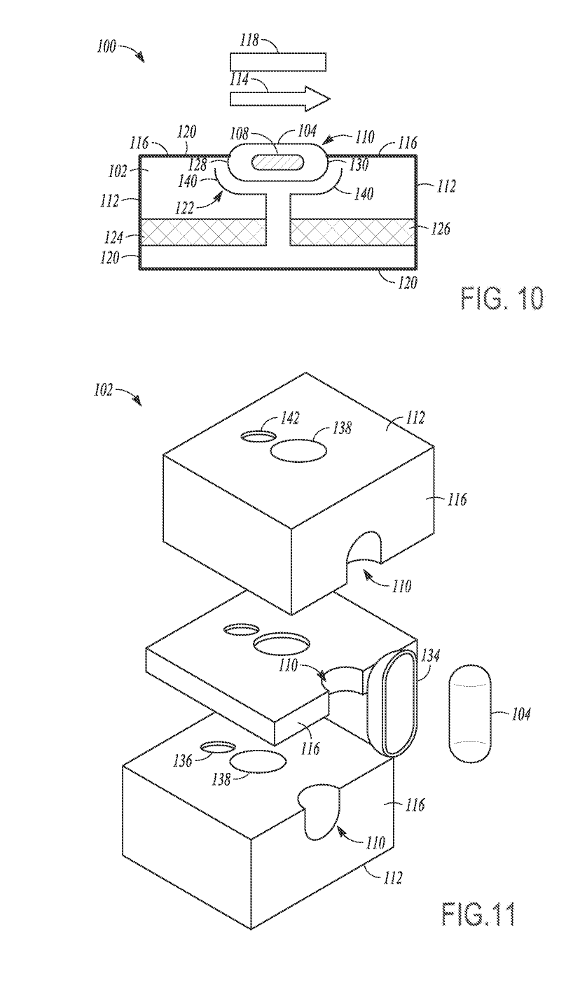

FIG. 10 is a cross-section and schematic view of a plasma lamp 100, according to an example embodiment. The plasma lamp 100 may have a lamp body 102 formed from one or more solid dielectric materials and a bulb 104 positioned adjacent to the lamp body 102. The bulb 104 contains a fill that is capable of forming a light emitting plasma. A lamp drive circuit (e.g., the lamp drive circuit 100 shown by way of example in FIG. 2A) couples RF power into the lamp body 102 which, in turn, is coupled into the fill in the bulb 104 to form the light emitting plasma. In example embodiments, the lamp body 102 forms a structure that contains and guides the RF power.

The bulb 104 is positioned or oriented in the plasma lamp 100 so that a length of a plasma arc 108 generally faces a lamp opening 110 (as opposed to facing side walls 112) to increase an amount of collectable light emitted from the plasma arc 108 in a given Etendue. Since the length of plasma arc 108 orients in a direction of an applied electric field, the lamp body 102 and the coupled RF power are configured to provide an electric field 114 that is aligned or substantially parallel to the length of the bulb 104 and a front or upper surface 116 of the lamp body 102. Thus, in an example embodiment, the length of the plasma arc 108 may be substantially (if not completely) visible from outside the lamp body 102. In example embodiments, collection optics 118 may be in the line of sight of the full length of the bulb 104 and plasma arc 108. In other examples, about 40% to 100% (or any range subsumed therein) of the plasma arc 108 may be visible to the collection optics 118 in front of the lamp 100. Accordingly, the amount of light emitted from the bulb 104 and received by the collection optics 118 may be enhanced. In example embodiments, a substantial amount of light may be emitted out of the lamp 100 from the plasma arc 108 through a front side wall of the lamp 100 without any internal reflection. As described herein, the lamp body 102 is configured to realize the necessary resonator structure such that the light emission of the lamp 100 is enabled while satisfying Maxwell's equations.

With continuing reference to FIG. 10, the lamp 100 is shown to include the lamp body 102 including a solid dielectric body and an electrically conductive coating 120, which extends to the front or upper surface 116. The lamp 100 is also shown to include dipole arms 122 and conductive elements 124, 126 (e.g., metalized cylindrical holes bored into the lamp body 102) to concentrate the electric field present in the lamp body 102. The dipole arms 122 may thus define an internal dipole. In an example embodiment, a resonant frequency applied to a lamp body 102 without dipole arms 122 and conductive elements 124, 126 may result in a high electric field at the center of the solid dielectric lamp body 102. This is based on the intrinsic resonant frequency response of the lamp body due to its shape, dimensions, and relative permittivity. However, in the example embodiment of FIG. 10, the shape of the standing waveform inside the lamp body 102 is substantially modified by the presence of the dipole arms 122 and conductive elements 124, 126 and the electric field maxima is brought out to end portions 128, 130 of the bulb 104 using the internal dipole structure. This results in the electric field 114 near the upper surface 116 of the lamp 100 that is substantially parallel to the length of the bulb 104. In some example embodiments, this electric field is also substantially parallel to a drive probe and feedback probe.

The fact that the plasma arc 108 in lamp 100 is oriented such that it presents a long side to the lamp exit aperture or opening 110 may provide several advantages. The basic physical difference relative to an “end-facing” orientation of the plasma arc 108 is that much of the light can exit the lamp 100 without suffering multiple reflections within the lamp body 102. Therefore, a specular reflector may show a significant improvement in light collection performance over a diffuse reflector that may be utilized in a lamp with an end-facing orientation. An example embodiment of a specular reflector geometry that may be used in some embodiments is a parabolic line reflector, positioned such that the plasma arc 108 lies in the focal-line of the reflector.

Another advantage may lie in that the side wall of the bulb 104 can be relatively thick, without unduly inhibiting light collection performance. Again, this is because the geometry of the plasma arc 108 with respect to the lamp opening 110 is such that most of the light emanating from the plasma arc 108 will traverse thicker walls at angles closer to normal and will traverse them only once or twice (or at least a reduced number of times). In example embodiments, the side wall of the bulb 104 may have a thickness in the range of about 1 mm to 10 mm or any range subsumed therein. In one example, a wall thickness greater than the interior diameter or width of the bulb may be used (e.g., 2 mm to 4 mm in some examples). Thicker walls may allow higher power to be coupled to the bulb 104 without damaging the wall of the bulb 104. This is an example only and other embodiments may use other bulbs. It will be appreciated that the bulb 104 is not restricted to a circular cylindrical shape and may have more than one side wall.

Continuing with FIG. 10, the dipole arms 122 extend from a central portion of the bulb 104 in opposite directions out toward the ends of the bulb 128 and 130. In the central portion, the dipole arms 122 are closely spaced from one another and extend parallel to one another down to conductive elements 124 and 126. In the central portion, the dipole arms 122 may be 2 mm to 10 mm apart, or 2 mm to 5 mm in some embodiments. In a particular example, the dipole arms 122 are 3 mm apart in the central region. These closely spaced dipole arms 122 provide a capacitance and concentrate a high electric field near the bulb 104. The arms extend to end portions 140, which spreads the electric field along the length of the bulb 104.

The central conductors 124, 126 and extending arms 122 form a dipole antenna structure and power is near-field coupled from the dipole antenna to the bulb. The electrically conductive coating 120 helps prevent far-field radiation and electromagnetic interference, as further described below. While the central conductors of the dipole arms 122 provide a capacitance in the lamp body, the conductive elements 124 and 126 provide an inductance and tend to concentrate the magnetic field. The dipole arms 122 and conductive elements 124 and 126 form a resonant structure in some embodiments. A probe may be used to provide RF power to the dielectric lamp body, which is received by the resonant structure and coupled to the load in the bulb 104 by the dipole antenna.

In example embodiments, the RF power is provided at a resonant frequency for the resonant antenna structure (comprising the dipole arms 122, conductive elements 124 and 126, and dielectric material between these elements). This power coupling may be referred to as antenna coupling of RF power to the load in the bulb. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In the example shown in FIG. 10, the dipole arms 122 extend toward the ends of the bulb 128 and 130, but end before reaching the upper surface 116 of the lamp body 102, which may be covered with an electrically conductive coating 120 that is grounded. In this example, the end portions 140 of the dipole arms 122 form antenna electrodes. These end portions 140 end before crossing the mid-point of the bulb (taken along the axis of the bulb's length) and do not surround the furthest end points on the bulb at 128 and 130.

FIG. 11 is a perspective exploded view of the lamp body 102, according to an example embodiment. In FIG. 11, the bulb 104 is positioned horizontally relative to an outer upper surface of the lamp body 102.

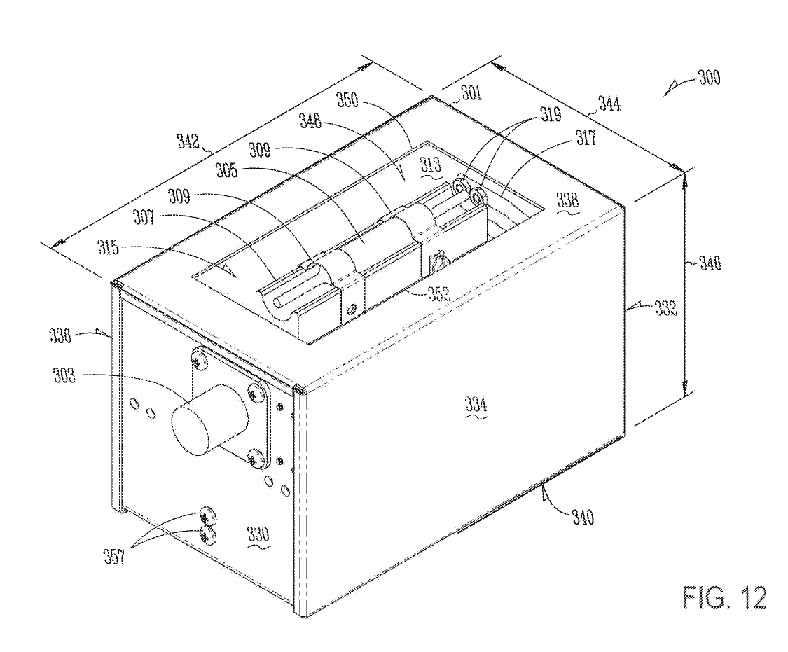

FIG. 12 is another schematic representation of an example embodiment of an electrodeless plasma lamp 300. The plasma lamp 300 is operatively coupled to a power source and is shown, by way of example, to include a conductive enclosure 301, an RF input port 303, a bulb 305, a bulb support arrangement such as a ceramic carrier 307, and a pair of conductive elements or straps 309. In an example embodiment, the conductive enclosure 301 is a parallelepiped and has parallel spaced end walls 330 and 332, parallel spaced sidewalls 334 and 336, and parallel spaced top and bottom walls 338 and 340. The plasma lamp 300 is further shown to include a dielectric volume 313 within the conductive enclosure 301, a bulb assembly 315, a ground coil 317, and a pair of ground coil fasteners 319.

In an example embodiment the conductive enclosure 301 defines an air-filled resonator cavity and may also serve a variety of other functions. For example, the conductive enclosure 301 functions as an EMI constraint or shield, thus limiting an amount of EMI emitted from the enclosure 301. Additionally, the conductive enclosure 301 serves to conduct ground return current from the ground coil 317.

The conductive enclosure 301 can be fabricated from a number of different conductive materials such as aluminum or stainless steel (or any other suitable conductive material). Additionally, since the RF current skin depth is relatively shallow depending on frequency, the walls 330, 332, 334, 336, 338, and 340 of the conductive enclosure can be relatively thin. Accordingly, the conductive enclosure 301 can be constructed from a non-conductive material with a conductive coating or plating formed or otherwise deposited thereon. The conductive enclosure 301 can be fabricated in a variety of ways such as, for example, a deep drawn box, a U-shaped sheet metal with appropriate channel bends for the end components, cast material (e.g., cast aluminum), or a variety of other forming techniques known independently to a skilled artisan. Any seams may be soldered, braised, welded, adhered with conductive epoxy, or a variety of other attachment or sealing methods to limit EMI radiation emitted from the conductive enclosure 301. The top wall 338 may define an enclosure cover that can be, for example, formed or stamped and screwed, welded, or otherwise conductively adhered to the walls 330, 332, 334, and 336. In an example embodiment, the dielectric volume 313 within the conductive enclosure 301 may be filled with air. In other embodiments, the dielectric volume 313 may be filled with solid, powdered, or fluid dielectrics. Many types of dielectric materials are known independently in the art.

In an example embodiment, the conductive enclosure 301 may have a length 342 of between 60 millimeters and 200 millimeters, a width 344 of between 40 millimeters and 200 millimeters, and a height 346 of between 40 millimeters and 200 millimeters. In some example embodiments, the length 342 is 130 mm, the width 344 is 80 mm and the height 346 is 80 mm, defining a rectangular box with square end walls 330, 332. Although shown, by way of example, as rectangular in shape, other shapes include, for example, square, cylindrical, and spherical enclosures. For example, walls 330, 332, 334, 336, 338, and 340 of the conductive enclosure 301 can be approximately 3 mm to 4 mm thick, although an exact thickness can be determined based on structural integrity required for a given application. The overall size of the conductive enclosure 301 can be varied depending upon a number of factors including interior inductor design and bulb size.

The top wall 338 has an opening 348 (e.g., a rectangular opening) with longitudinal edges 350, 352 that are spaced a minimum distance from the pair of mounting members or conductive straps 309 to prevent arc-over from the conductive straps 309 to the top wall 338. Arcing may also be prevented using other techniques. The conductive straps 309 may have an applied voltage from RF coils, discussed below, of approximately 2000 volts (as measured strap-to-strap). In an example, the distance may be between 2 millimeters and 20 millimeters for an applied voltage of between 100 volts and 10 kilovolts. The opening 348 may be sized to enhance the amount of light exiting the plasma lamp 300.

In an example embodiment, the ceramic carrier 307 defines an example seat or support in which the bulb 305 is received. In an example embodiment, the ceramic carrier 307 may have insulating formations that wrap over or cover the conductive straps 309 to reduce the possibility of arc-over.

The bulb assembly 315 may comprise the bulb 305, the ceramic carrier 307, and the pair of conductive straps 309. The bulb 305 may be similar to the various bulbs discussed herein. The ceramic carrier 307 that supports the bulb 305 may also serve as a heat sink or a diffuse scattering reflector to reflect light from the bulb 305 out of the plasma lamp 300. The ceramic carrier 307 may be formed from various materials that are at least partially thermally conductive and capable of reflecting at least visible light. One such material that can be used to form the ceramic carrier 307 is alumina (Al₂O₃).

In various embodiments, an apparatus is provided that includes an electrodeless plasma lamp with a lamp driver circuit. The lamp driver circuit may include a voltage-controlled oscillator to provide radio frequency power to the electrodeless plasma lamp. A radio frequency power detector is coupled to an output of the voltage-controlled oscillator to detect a level of reflected power from the electrodeless plasma lamp. A microprocessor is configured to receive signals from the radio frequency power detector and control a frequency of the voltage-controlled oscillator to minimize the reflected power from the electrodeless plasma lamp.

In some embodiments of the apparatus, the radio frequency detector is further configured to determine a state of operation of the electrodeless plasma lamp.

In some embodiments of the apparatus, an amplifier is coupled to an output of the voltage controlled oscillator to amplify the radio frequency power supplied to the electrodeless plasma lamp. A current sensor is coupled between the amplifier and the microprocessor to detect a level of current supplied to the electrodeless plasma lamp. The current sensor is further configured to determine a state of operation of the electrodeless plasma lamp.

In some embodiments of the apparatus, a radio frequency modulator is coupled between the voltage controlled oscillator and the microprocessor. An attenuator is coupled between the voltage controlled oscillator and the radio frequency modulator. The microprocessor is further configured to adjust the radio frequency modulator and the attenuator based on the level of current to maintain the level of current to the electrodeless plasma lamp.

In some embodiments of the apparatus, a matching circuit is coupled to an output of the amplifier to match an output impedance within the lamp driver circuit to a characteristic impedance of the electrodeless plasma lamp. In some embodiments of the apparatus, the matching circuit is configured to reduce a voltage standing wave ratio for each stage of the electrodeless plasma lamp.

In various embodiments, a method is provided that includes setting a variable voltage power supply to an ignition level for the electrodeless plasma lamp, setting a voltage-controlled oscillator to a frequency for the electrodeless plasma lamp, measuring reflected power from the electrodeless plasma lamp, and determining whether there is a drop in reflected power from the electrodeless plasma lamp. Based on a determination that there is a drop in the reflected power from the electrodeless plasma lamp an ignition flag is set. Based on a determination that there is not a drop in the reflected power from the electrodeless plasma lamp, the frequency of the voltage-controlled oscillator is incremented.

In some embodiments of the method, after incrementing the frequency of the voltage-controlled oscillator, the reflected power is measured from the electrodeless plasma lamp.

The present disclosure is therefore not to be limited in terms of the particular embodiments described in this application, which are intended as illustrations of various aspects. Many modifications and variations can be made, as will be apparent to a person of ordinary skill in the art upon reading and understanding the disclosure provided herein. Functionally equivalent methods and devices within the scope of the disclosure, in addition to those enumerated herein, will be apparent to a person of ordinary skill in the art from the foregoing descriptions. Portions and features of some embodiments may be included in, or substituted for, those of others. Many other embodiments will be apparent to those of ordinary skill in the art upon reading and understanding the description provided herein. Such modifications and variations are intended to fall within a scope of the appended claims. The present disclosure is to be limited only by the terms of the appended claims, along with the full scope of equivalents to which such claims are entitled. It is also to be understood that the terminology used herein is for the purpose of describing particular embodiments only and is not intended to be limiting.

What is claimed is:

1. An apparatus to drive an electrodeless plasma lamp, the apparatus comprising:
a lamp driver circuit including
a voltage-controlled oscillator to provide radio frequency power to the electrodeless plasma lamp;
a radio frequency power detector coupled to an output of the voltage-controlled oscillator, the radio frequency power detector configured to detect a level of reflected power from the electrodeless plasma lamp; and
a microprocessor configured to receive signals from the radio frequency power detector and control a frequency of the voltage-controlled oscillator to minimize the reflected power from the electrodeless plasma lamp.

2. The apparatus of claim 1, wherein the radio frequency power detector comprises a coupler and a radio frequency detector.

3. The apparatus of claim 2, wherein the radio frequency detector is further configured to determine a state of operation of the electrodeless plasma lamp.

4. The apparatus of claim 1, further comprising:
a variable voltage power supply configured to vary an output voltage proportionally in accordance with a control signal received from the microprocessor.

5. The apparatus of claim 1, further comprising:
a spread spectrum circuit coupled between the microprocessor and the voltage-controlled oscillator to adjust a signal to the voltage-controlled oscillator to spread frequencies generated by the voltage-controlled oscillator over a frequency range to reduce electromagnetic interference produced by the electrodeless plasma lamp.

6. The apparatus of claim 1, further comprising:
an amplifier coupled to an output of the voltage controlled oscillator to amplify the radio frequency power supplied to the electrodeless plasma lamp; and
a current sensor coupled between the amplifier and the microprocessor to detect a level of current supplied to the electrodeless plasma lamp, the current sensor further to determine a state of operation of the electrodeless plasma lamp.

7. The apparatus of claim 6, further comprising:
a radio frequency modulator coupled between the voltage controlled oscillator and the microprocessor; and
an attenuator coupled between the voltage controlled oscillator and the radio frequency modulator, the microprocessor being further configured to adjust the radio frequency modulator and the attenuator based on the level of current to maintain the level of current to the electrodeless plasma lamp.

8. The apparatus of claim 6, further comprising:
a matching circuit coupled to an output of the amplifier to match an output impedance within the lamp driver circuit to a characteristic impedance of the electrodeless plasma lamp.

9. The apparatus of claim 8, wherein the matching circuit is to reduce a voltage standing wave ratio for each stage of the electrodeless plasma lamp.

10. A method of starting an electrodeless plasma lamp, the method comprising:
setting a variable voltage power supply to an ignition level for the electrodeless plasma lamp;
setting a voltage-controlled oscillator to a frequency for the electrodeless plasma lamp;
measuring reflected power from the electrodeless plasma lamp;
determining whether there is a drop in reflected power from the electrodeless plasma lamp;
based on a determination that there is a drop in the reflected power from the electrodeless plasma lamp, setting an ignition flag; and
based on a determination that there is not a drop in the reflected power from the electrodeless plasma lamp, incrementing the frequency of the voltage-controlled oscillator.

11. The method of claim 10, further comprising:
prior to measuring the reflected power from the electrodeless plasma lamp, delaying measuring the reflected power for a time period to allow the lamp to adjust to an output level from the variable voltage power supply.

12. The method of claim 10, further comprising:
after incrementing the frequency of the voltage-controlled oscillator, measuring the reflected power from the electrodeless plasma lamp.
